(19) United States
(12) Patent Application Publication
(10) Pub. No.: US 2019/0226458 A1
(43) Pub. Date: Jul. 25, 2019

(54) Aerodynamic Shroud and Method

(71) Applicant: Simon Sanderson, Norfolk (GB)

(72) Inventor: Simon Sanderson, Norfolk (GB)

(21) Appl. No.: 15/576,579

(22) PCT Filed: May 20, 2016
(86) PCT No.: PCT/GB2016/051460

§ 371 Date: Mar. 23, 2018

(30) Foreign Application Priority Data
May 22, 2015 (GB) 1508827.1

(51) Int. Cl. F03D 80/50

(52) U.S. Cl. CPC F03D 80/50; F05B 2230/80; F05B 2260/95

(57) ABSTRACT

A leading edge of a wind-turbine blade has a carefully designed predetermined shape. After operation of the blade, erosion damages that shape and the blade needs repair. Repair is difficult to carry out in the field or, for offshore turbines, at sea. A shroud (8) for repairing a damaged leading edge of a wind-turbine blade (2) is rigid and has a shape matching the predetermined shape of the leading edge. Advantageously the shroud has a multi-layered structure in which a base layer (10) of the shroud comprises a rigid material.

The invention relates to an aerodynamic shroud and associated methods for making and using the aerodynamic shroud. In particular, the invention relates to apparatus and methods for repairing erosion of leading edges of wind-turbine blades.

Large wind-turbine blades rotate with very high tip speeds, sometimes in excess of 100 m/s. This causes very severe erosion conditions, particularly along the outer third or half of the blade leading edge, closest to the tip.

Repair of leading edges is difficult because it is typically carried out in situ, with the blade mounted on the turbine. This is a particularly difficult problem with off-shore turbines, where gaining access to carry out work on a blade is time-consuming and dangerous, and any repair must be carried out while exposed to the weather.

Wind-turbine blades are currently repaired as follows. A blade is a fibre-composite structure, with a gel-coat surface. In a repair of an eroded leading edge, all of the damaged gel coat and glass fibre material must be ground away and sanded smooth. The eroded and removed material is then replaced by the same number and type of glass fibre laminates using glass fibre cloth and laminating resin. This is then sanded smooth to the original aerofoil shape of the blade. Finally a coat of gel coat or paint is applied over the repair to protect it.

When this has been carried out, leading-edge protection in the form of blade-protection coatings or blade-protection tapes may be applied to protect the repaired leading edge.

Blade-protection coatings may be applied in liquid form and set, or cure, to form a protective layer over the leading edge. A blade-protection coating may typically be a two-component polyurethane or epoxy, which is mixed prior to application.

A blade-protection tape is constructed from erosion-resistant materials and can flexibly conform to the shape of the leading edge of the wind-turbine blade. The tape is applied using an adhesive.

### SUMMARY OF INVENTION

The invention provides an apparatus and method as defined in the appended independent claims, to which reference should now be made. Preferred or advantageous features of the invention are set out in dependent claims.

The invention may therefore provide a rigid, or pre-shaped, shroud or capping having an external aerodynamic profile matched to a desired or pre-determined leading-edge profile of a wind-turbine blade or a portion of a wind-turbine blade. The shroud may have an internal profile shaped to match the leading edge or to match the leading edge after erosion during use.

The invention may also provide methods for fabricating such shrouds and for using such shrouds to repair eroded wind-turbine blades.

As described above, conventional methods for repairing eroded wind-turbine blades require manual removal and reconstruction of damaged material to rebuild, as far as possible, the original shape of the leading edge, followed by the application of coatings or tapes which conform to the shape of the repaired leading edge. However, the blade designer has taken great care to optimise the aerodynamic profile of the blade during manufacture, and erosion of a wind-turbine blade in service changes the aerodynamic profile, particularly at its leading edge. Repairing an eroded leading edge using conventional methods may not be able to accurately restore the designer's intended, optimised, aerodynamic blade profile.

The invention may advantageously solve this problem by providing a shaped repair shroud for the leading edge of a blade which not only repairs the erosion damage and protects the blade from further erosion, but also restores its desired aerodynamic profile. Advantageously, use of such a repair shroud eliminates the requirement to repair the eroded leading edge by removing damaged material and rebuilding the leading edge itself. This may greatly improve the speed and effectiveness of in-situ blade repairs.

The shroud preferably has a U-shaped cross section that, in use, fits over the leading edge of a wind-turbine blade. A wind-turbine blade is typically tapered towards its tip, and so a shroud intended for repairing or protecting a specific wind-turbine blade may be correspondingly tapered. A shroud for repairing a wind-turbine blade is therefore preferably shaped to fit a specific portion of a specific model of turbine blade. A shroud may be manufactured to fit any portion of a leading edge of a wind-turbine blade but it is known that erosion occurs more rapidly towards the tip of a wind-turbine blade where blade speeds are highest. A shroud may therefore typically be manufactured to fit an outer portion of the wind-turbine blade near the tip. This may be the outer third or outer half of the length of the blade, for example.

A shroud may advantageously have a multi-layered structure, for example having a base layer which is in use adjacent to the leading edge of the blade, and an outer layer or surface layer which, in use, forms a replacement leading edge for the blade.

The base layer may comprise a rigid material, providing structural support for the shroud. The rigid material may, for example, be a fibre-reinforced composite material. The outer layer may, for example, be a tough, abrasion resistant and impact absorbing layer of paint or coating.

It is important that the shroud extends sufficiently far around the sides of the wind-turbine blade, behind the leading edge, to provide an efficient aerodynamic shape. It is also desirable for the trailing edges of the shroud, on each side of the blade, to progressively reduce in thickness, or taper, away from the leading edge in order to provide a smooth transition of the air flow back onto the blade. In other words the trailing edges of the shroud are tapered, or feathered, edges.

A further aspect of the invention provides a method for fabricating a shroud as described above. Preferably, the shroud is fabricated using a mould which matches the shape of the turbine blade to which the shroud is designed to fit.

A suitable mould may, for example, be the leading edge of a new turbine-blade, which has not yet suffered erosion, or a purpose-built mould having the same shape.

The shroud may be a multi-layered structure but must contain at least one layer which may be sufficiently rigid to retain the desired shape of the shroud, both while a repair is being made and when the shroud is in position on a blade. The rigid layer may, for example, be of a fibre-reinforced material comprising fibres and a curable resin. This layer may be shaped in a mould as described above, and the resin cured so that the layer retains its shape.

Advantageously, the rigid layer may be a base layer of the shroud, which is adjacent to the wind-turbine blade leading edge when the shroud is used to repair the blade. The rigid layer may thus be used to compensate for, or functionally to replace or protect, damaged material in the leading edge of the eroded blade.

The shroud may comprise further layers, such as an outer layer of abrasion resistant and impact absorbing material. This may be applied after the rigid layer has been moulded, and may be applied as a paint or coating in one or several thin layers over the pre-formed moulded rigid layer.

A further aspect of the invention provides a method for repairing a leading edge of a wind-turbine blade. The method may advantageously involve gluing a shroud as described above to a leading edge of a wind-turbine blade. Preferably, the surface of the leading edge may be prepared, for example by sanding, before application of an appropriate glue or adhesive. As noted above, however, removal of erosion-damaged material from the leading edge may not be required.

The shroud embodying the invention may be considered as leading-edge armour, intended both to repair leading-edge damage near the tips of wind-turbine blades and to protect them from further erosion for as long a period as possible. The shroud is advantageously moulded to the exact shape of each type of blade to be repaired and protected, so that it can be glued over the leading edge after suitable preparation, for example by sanding. Advantageously, the application of the shroud restores a desired leading-edge shape, for example as originally designed by the blade designer, and avoids any need to try to repair the leading-edge erosion as in the prior art; the eroded leading edge is simply covered by the shroud.

The shroud may conveniently be manufactured in a workshop away from the wind-turbine blades being repaired, minimising the difficulty of the repair operation in the field. The shroud may be manufactured using an existing blade as a male mould, or using an exact copy of the original blade as a male mould.

The shroud may comprise two or more layers of different materials. A base layer may be stiff and hard, and shaped by moulding over the mould of the blade tip leading edge. The base layer may be made of a tough composite material, which is placed over the mould in multiple pre-cut layers, before being vacuumed down onto the male mould and cured. One or more surface layers, or top layers, may then be applied. These may comprise an impact-absorbing layer of paint or coating, applied in one or several thin layers.

In a preferred embodiment, a shroud may be used to repair a blade by gluing the base layer of the shroud to the damaged leading edge of the blade. Advantageously, the surface layer of the shroud is intended to absorb shock waves due to impact by rain, hail or other particles in the air. The base layer may additionally help to absorb shock waves, by forming a secondary protective layer, with the intention of avoiding shock waves travelling into the blade below. Thus, the operating life of the blade may be extended or maximised.

The shroud may also be made of materials able to protect the blade from ultraviolet radiation.

The layers of the shroud are advantageously tapered down away from the leading edge to provide a smooth transition of the air flow back onto the blade, maintaining the performance of the wind-turbine blade.

Embodiments of the invention may thus advantageously allow leading-edge erosion repairs to be carried out more rapidly and more easily than by using conventional methods, while at the same time retaining or restoring the full aerodynamic performance of the blade and providing the blade with protection from subsequent leading-edge erosion, increasing blade service intervals and slowing the reduction in blade efficiency due to erosion.

### DESCRIPTION OF SPECIFIC EMBODIMENTS

Specific embodiments of the invention will now be described by way of illustrative and enabling example only, with reference to the accompanying drawings, in which:

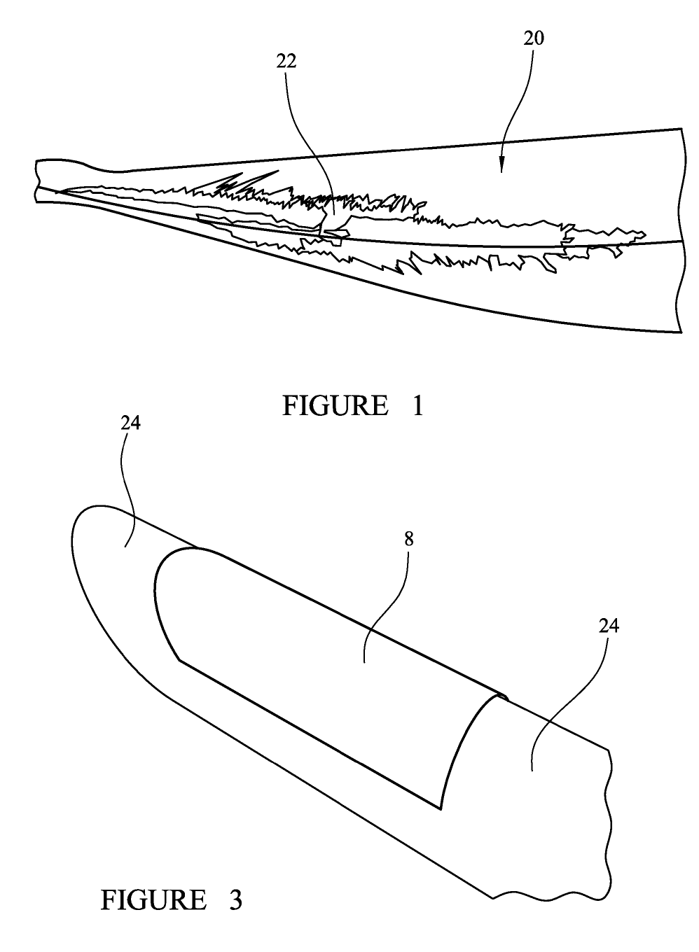

FIG. 1 is an image of an eroded wind-turbine blade;

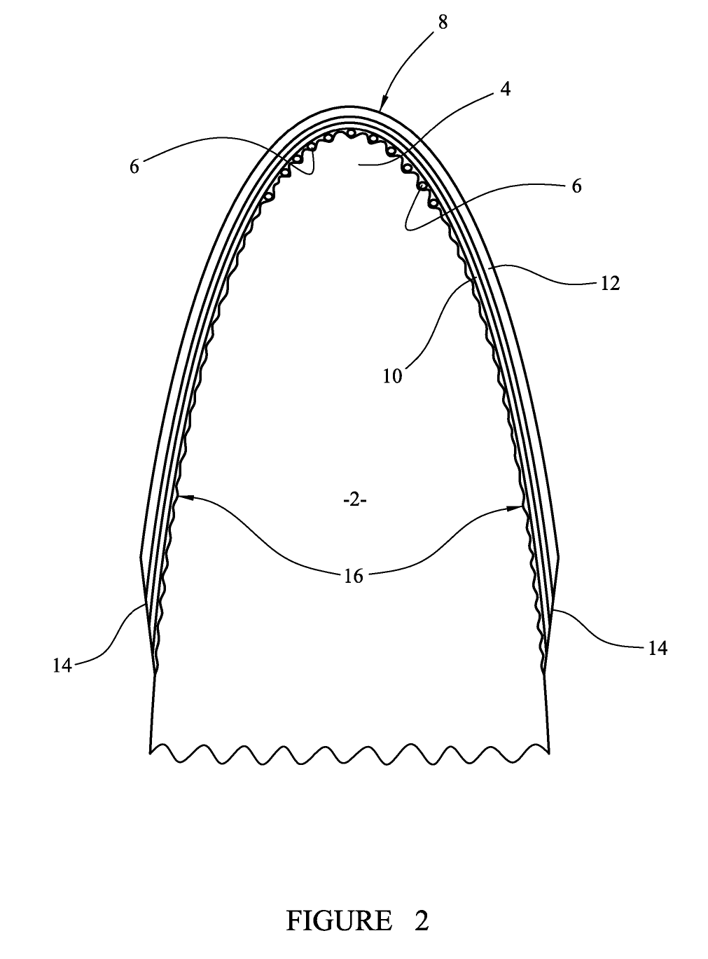

FIG. 2 is a schematic cross-section of a shroud according to a first embodiment of the invention in position on a wind-turbine blade leading edge;

FIG. 3 is a perspective view of a shroud embodying the invention in position on a mould, which has been used to form the shroud; and

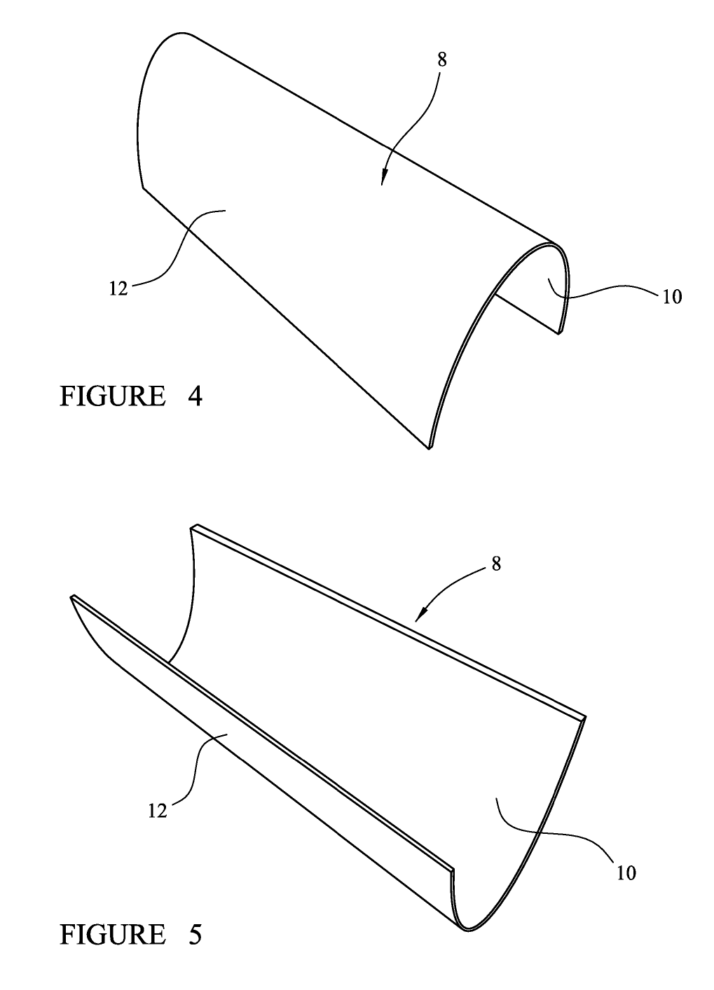

FIGS. 4 and 5 are perspective views of the exterior and interior surfaces of the shroud of FIG. 3.

FIG. 1 is an image of a wind-turbine blade 20 showing erosion of the leading edge 22 after a period of service. As can clearly be seen, the erosion has changed the shape of the leading edge, which may lead to a significant reduction of aerodynamic efficiency.

FIG. 2 shows a schematic transverse section of a wind-turbine blade 2, showing the leading edge 4 and a portion of the blade behind the leading edge.

In the same way as shown in FIG. 1 the blade has been in use for a period of time and erosion has damaged the leading edge, causing loss of material 6 and damaging the aerodynamic profile of the blade.

A shroud 8 embodying the invention has been used to repair the leading edge. The shroud has a U-shaped cross-section and is formed with a multi-layered structure. A base layer 10 of the shroud is adjacent to the blade surface and comprises a rigid, fibre-reinforced material. The base layer is typically formed of more than one individual layer of a thermosetting or thermoformed composite material. Suitable materials are glass-fibre or carbon-fibre or Kevlar-fibre reinforced with a two-component epoxy or other curable resin, or a thermoplastic matrix. The matrix may be toughened by the addition of a particulate reinforcement, such as rubberised or nano-particle constituents.

An outer layer, or top layer, 12 of the shroud comprises a paint or coating or other film, such as a polyurethane, epoxy-urethane, or siloxane materials.

The trailing edges of the shroud, spaced from the leading edge, are tapered 14 to allow airflow passing over the shroud, in use, to flow onto the blade surface, in order to optimise aerodynamic performance.

The shroud is glued to the blade using a single or two-part glue 16. The glue preferably has a setting time which is long enough to allow application of the shroud to the blade in the field. Suitable glues, or adhesives may be two-part epoxy adhesives, two-part methyl acrylate, two-part polyurethane, or a glue film.

The shape of the rigid shroud matches the shape of the blade, at and on either side of its leading edge.

It should be noted that in the schematic cross-section of FIG. 1, the thickness of the shroud has been exaggerated significantly in order to illustrate its layered structure. In practice, the depth of the shroud, from its leading edge to its tapering rear edges, is more than about 80 mm or 100 mm or 125 mm and less than about 250 mm or 200 mm or 150 mm. At the leading edge, the thickness of the base layer is about 1 mm and the thickness of the outer layer about 0.5 mm. The total thickness reduces towards the tapered trailing edges. For repairing a typical wind-turbine blade, the shroud may be between 5 m and 7 m long, for installation on the portion of the blade near the tip of the blade.

It is preferable that the shroud extends sufficiently far behind the leading edge of the blade, around the sides of the blade, so that airflow over the shroud flows smoothly onto and over the trailing edge of the blade. Thus, for example, where a central portion of the shroud is positioned over a leading edge of a blade, the trailing edges of the shroud are preferably at an angle of more than 50°, or more than 60° or 70° or 80°, to a plane tangential to the central portion.

FIG. 3 is three-quarter view of a shroud 8 in position on a mould 24 which has been used to make the shroud.

FIGS. 4 and 5 are a three-quarter views of the front side and the underside of a shroud 8, showing the shape of the rigid shroud and the base layer 10 and the outer layer 12.

FIGS. 3 to 5 show a shroud which, for the purposes of illustration, is much shorter in length than would be used to repair a longer portion of a blade. The shroud in the figures is about 50 cm long. A full-length shroud may be 5 m to 7 m long as described above.

To a fabricate a shroud as illustrated in FIGS. 2 to 5, layers of a suitable composite material, such as glass/epoxy prepreg (pre-impregnated sheet), carbon/epoxy prepreg or Kevlar/epoxy prepreg are placed over a male mould 24 having a shape identical to an unused wind-turbine blade of the type intended for repair. A vacuum may be applied between the male mould and a corresponding female mould placed over the prepreg as the matrix of the composite material is cured. The shaped composite material may then be removed from the mould and the outer layer added by painting or other coating technique. The tapered rear edges of the shroud are preferably formed during the moulding and coating processes.

1. A shroud for repairing a leading edge of a wind-turbine blade, the leading edge having a predetermined shape, the shroud being rigid and having a shape matching the predetermined shape of the leading edge.

2. A shroud according to claim 1, having a U-shaped cross section that, in use, fits over the leading edge of the wind-turbine blade.

3. A shroud, according to claim 1, in which in use a central portion of the shroud is adjacent to the leading edge of the wind-turbine blade, and side portions of the shroud are at an angle of more than 60° to a plane tangential to the central portion.

4. A shroud according to claim 1, in which side portions of the shroud end at tapered trailing edges of the shroud.

5. A shroud according to claim 1, having a multi-layered structure in which a base layer of the shroud comprises a rigid material.

6. A shroud according to claim 5, in which the rigid material comprises a fibre-reinforced composite.

7. A shroud according to claim 1, having a multi-layered structure in which an outer layer of the shroud comprises an impact-absorbing material.

8. A method for repairing or protecting a leading edge of wind-turbine blade by securing over the leading edge a shroud as defined in claim 1.

9. A method according to claim 8, comprising securing the shroud with an adhesive.

10. A method for making a shroud for repairing a leading edge of a wind-turbine blade, comprising moulding at least a first portion of the shroud using a mould having the same shape as the leading edge of the wind-turbine blade.

11. A method according to claim 10, in which the portion of the shroud formed using the mould is a rigid support layer of the shroud.

12. A method according to claim 11, in which the support layer comprises a fibrous material reinforced with a curable resin, and the resin is cured in the mould to form a rigid shroud matching the shape of the leading edge of the wind-turbine blade.

13. A method according to claim 11, in which the support layer is a base layer which, in use, is adjacent to the leading edge of the wind-turbine blade.

14. A method according to claim 10, comprising the step of applying a further portion of the shroud after the moulding of the first portion of the shroud.

15. A method according to claim 14, in which the further portion is an outer layer forming, in use, a replacement leading edge of the wind-turbine blade.

16-19. (canceled)
